(19) United States
(12) Patent Application Publication
(10) Pub. No.: US 2025/0014159 A1
(43) Pub. Date: Jan. 9, 2025

(54) NETWORK MANAGEMENT APPARATUS, NETWORK MANAGEMENT METHOD, AND VIDEO IMAGE DISTRIBUTION SYSTEM

(71) Applicant: NEC CORPORATION, Minato-ku, Tokyo (JP)

(72) Inventors: Anan SAWABE, Tokyo (JP); Yusuke SHINOHARA, Tokyo (JP); Takanori Iwai, Tokyo (JP); Koichi NIHEI, Tokyo (JP)

(73) Assignee: NEC Corporation, Minato-ku, Tokyo (JP)

(21) Appl. No.: 18/690,855

(22) PCT Filed: Sep. 28, 2021
(86) PCT No.: PCT/JP2021/035602

§ 371 Date: Mar. 11, 2024

(51) Int. Cl. G06T 7/00

(52) U.S. Cl. CPC G06T 7/0002; G06T 2207/30168

(57) ABSTRACT

A network management apparatus (100B) according to the present disclosure includes: an acquisition unit (111) configured to acquire, in order to recognize a target object from a video image, a required quality indicating quality of the video image required by a video image distribution apparatus configured to distribute the video image; a first calculation unit (112) configured to calculate an analysis performance for analyzing the video image based on the required quality acquired by the acquisition unit (111), the analysis performance enabling the target object to be recognized; and a second calculation unit (113) configured to calculate a parameter related to the distribution of the video image based on the analysis performance calculated by the first calculation unit (112).

### TECHNICAL FIELD

The present disclosure relates to a network management apparatus, a network management method, and a video image distribution system.

### BACKGROUND ART

Recently, the emergence of local 5G (Fifth Generation) has been making it possible for local governments and private business operators (users) to construct mobile networks and operate the mobile networks by themselves.

Examples of the above include a private citizen constructing a mobile network for the purpose of collecting video images from a monitoring camera and detecting whether or not target objects (e.g., a person, a face) are included in the video images.

Further, a technology for efficiently operating mobile networks has been attracting attention.

For example, Patent Literature 1 disclose a technology for achieving both improvement of a system Quality of Experience (QoE) and improvement of a service priority and a system throughput. According to the technology disclosed in Patent Literature 1, the amount of resources (throughputs) that satisfies the required QoE is determined using a QoE function indicating a relationship between a bit rate and the QoE.

### CITATION LIST

### Patent Literature

Patent Literature 1: Japanese Patent No. 5011408

### SUMMARY OF INVENTION

### Technical Problem

However, a sufficient communication band required for a distribution of a video image may not be secured depending on the state of the network.

For example, in the case of a video image used to detect target objects, such as a video image captured by a monitoring camera, a video image bit rate when the video image is distributed is likely to increase in order to maintain a high accuracy of recognition. However, when the video image bit rate increases, it is difficult to secure a sufficient communication band.

Therefore, in view of the above-described problem, an object of the present disclosure is to provide a network management apparatus, a network management method, and a video image distribution system that are capable of efficiently distributing a video image while maintaining the accuracy of recognition.

### Solution to Problem

A network management apparatus according to an example aspect includes:
an acquisition unit configured to acquire, in order to recognize a target object from a video image, a required quality indicating quality of the video image required by a video image distribution apparatus configured to distribute the video image;
a first calculation unit configured to calculate an analysis performance for analyzing the video image based on the required quality acquired by the acquisition unit, the analysis performance enabling the target object to be recognized; and
a second calculation unit configured to calculate a parameter related to the distribution of the video image based on the analysis performance calculated by the first calculation unit.

A network management method according to an example aspect includes:
an acquisition step of acquiring, in order to recognize a target object from a video image, a required quality indicating quality of the video image required by a video image distribution apparatus configured to distribute the video image;
a first calculation step of calculating an analysis performance for analyzing the video image based on the required quality acquired in the acquisition step, the analysis performance enabling the target object to be recognized; and
a second calculation step of calculating a parameter related to the distribution of the video image based on the analysis performance calculated in the first calculation step.

A network system according to an example aspect includes:
an acquisition unit configured to acquire, in order to recognize a target object from a video image, a required quality indicating quality of the video image required by a video image distribution apparatus configured to distribute the video image;
a first calculation unit configured to calculate an analysis performance for analyzing the video image based on the required quality acquired by the acquisition unit, the analysis performance enabling the target object to be recognized; and
a second calculation unit configured to calculate a parameter related to the distribution of the video image based on the analysis performance calculated by the first calculation unit.

### Advantageous Effects of Invention

According to the above-described example aspects, it is possible to achieve an effect that a network management apparatus, a network management method, and a network system that are capable of efficiently distributing a video image while maintaining the accuracy of recognition can be provided.

### BRIEF DESCRIPTION OF DRAWINGS

FIG. 1 is a block diagram showing a configuration example of a video image distribution system according to a first example embodiment;

FIG. 2 is a flow diagram for explaining an example of a schematic operation flow of the video image distribution system according to the first example embodiment;

FIG. 3 is a block diagram showing an example of a configuration of a network management apparatus according to a second example embodiment;

FIG. 4 is a diagram showing an example of a configuration of a video image distribution system assumed in each of third to fifth example embodiments;

FIG. 5 is a diagram for explaining an example of a method for setting a video image bit rate in each of the third to the fifth example embodiments and the related art;

FIG. 6 is a diagram for explaining Family-wise recognition performed in each of the third to the fifth example embodiments from a solution perspective;

FIG. 7 is a diagram for explaining Family-wise recognition performed in each of the third to the fifth example embodiments from a technical perspective;

FIG. 8 is a block diagram showing an example of a configuration of a network management apparatus according to the third example embodiment;

FIG. 9 is a diagram for explaining a definition example of a recognition rate according to the third example embodiment;

FIG. 10 is a diagram for explaining an example of a Recall-to-frame function according to the third example embodiment;

FIG. 11 is a diagram for explaining an example of an approximate curve approximating a Recall-to-video image bit rate function according to the third example embodiment;

FIG. 12 is a diagram for explaining an example of a method for collecting video image bit rate-to-Recall data;

FIG. 13 is a diagram for explaining an example of a method for calculating an approximate curve shown in FIG. 11;

FIG. 14 is a diagram for explaining an example of a result of a video image bit rate-to-recognition rate according to the third example embodiment;

FIG. 15 is a flow diagram for explaining an example of a schematic operation flow of the network management apparatus according to the third example embodiment;

FIG. 16 is a block diagram showing an example of a configuration of a video image distribution system according to the fourth example embodiment;

FIG. 17 is a block diagram showing an example of a configuration of a video image distribution system according to the fifth example embodiment; and

FIG. 18 is a block diagram showing an example of a hardware configuration of a computer that implements the network management apparatus according to each of the second to the fifth example embodiments.

### EXAMPLE EMBODIMENT

Example embodiments according to the present disclosure will be described hereinafter with reference to the drawings. Note that, for the clarification of the description, the following descriptions and the drawings are partially omitted and simplified as appropriate. Further, the same elements are denoted by the same reference symbols throughout the drawings, and redundant descriptions are omitted as necessary. Further, specific numerical values and the like stated in the following example embodiments are merely examples for facilitating understanding of the present disclosure, and are not limited thereto.

### First Example Embodiment

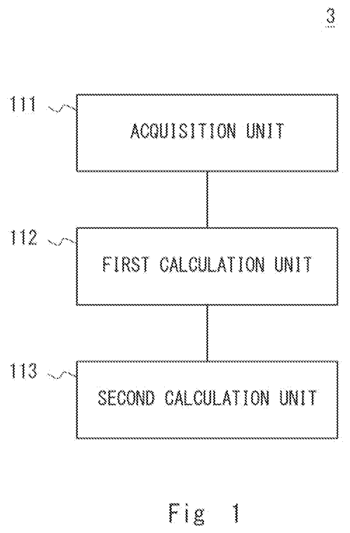

First, an example of a configuration of a video image distribution system 3 according to a first example embodiment will be described with reference to FIG. 1.

As shown in FIG. 1, the video image distribution system 3 according to the first example embodiment includes an acquisition unit 111, a first calculation unit 112, and a second calculation unit 113.

In order to recognize a target object from a video image, the acquisition unit 111 acquires a required quality indicating the quality of the video image required by a video image distribution apparatus that distributes the video image. The acquisition unit 111 corresponds to a quality storage unit 101 described later.

The first calculation unit 112 calculates an analysis performance of the video image which enables the target object to be recognized based on the required quality acquired by the acquisition unit 111. The first calculation unit 112 corresponds to a configuration in which a number-of-frames-in-required-delay calculation unit 102, a Recall-to-frame function calculation unit 103, and a required Recall calculation unit 104, which units will be described later, are combined with each other.

The second calculation unit 113 calculates a parameter related to the distribution of the video image based on the analysis performance calculated by the first calculation unit 112. The second calculation unit 113 corresponds to a configuration in which a Recall-to-video image bit rate function storage unit 105 and a required video image bit rate calculation unit 106, which units will be described later, are combined with each other.

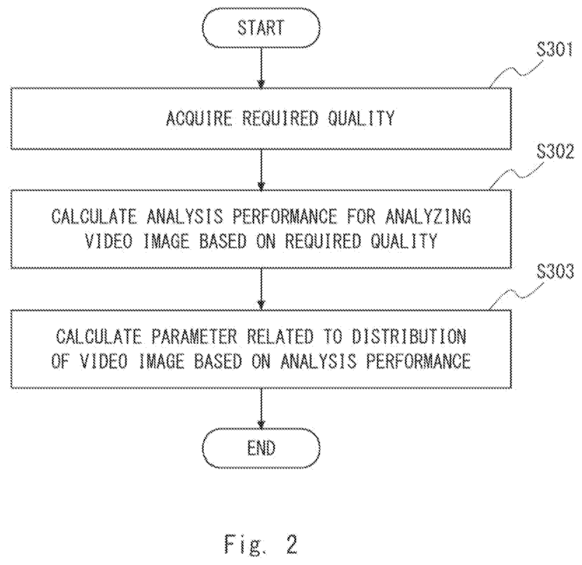

Next, an example of a schematic operation flow of the video image distribution system 3 according to the first example embodiment will be described with reference to FIG. 2.

As shown in FIG. 2, in order to recognize a target object from a video image, the acquisition unit 111 first acquires a required quality indicating the quality required for the video image (Step S301).

Next, the first calculation unit 112 calculates an analysis performance for analyzing the video image which enables the target object to be recognized based on the required quality acquired by the acquisition unit 111 (Step S302).

Then, the second calculation unit 113 calculates a parameter related to the distribution of the video image based on the analysis performance calculated by the first calculation unit 112 (Step S303).

As described above, according to the first example embodiment, an analysis performance for analyzing a video image which enables the target object to be recognized is calculated based on a required quality, and a parameter related to the distribution of the video image is calculated based on the calculated analysis performance. By doing so, it is possible to efficiently distribute a video image while maintaining the required quality (the accuracy of recognition).

Note that the acquisition unit 111 may further acquire a video image quality of the video image. Further, the first calculation unit 112 may calculate the analysis performance based on the required quality and the video image quality acquired by the acquisition unit 111.

Further, the acquisition unit 111 may acquire a required recognition rate indicating a recognition rate required for the video image and a required amount of delay indicating an amount of delay required for the video image as the required quality, and may acquire a frame rate of the video image as the video image quality. Further, the recognition rate may be a rate at which the target object is recognized in at least one video image frame among a plurality of video image frames.

Further, the first calculation unit 112 may calculate the number of frames in the required delay indicating the number of frames of the video image frame generated within the required amount of delay based on the required amount of delay and the frame rate acquired by the acquisition unit 111. Further, the first calculation unit 112 may calculate a first function indicating a relationship between a recall rate and the number of frames of the video image frame when the required recognition rate is the required recognition rate acquired by the acquisition unit 111. The first function corresponds to a Recall-to-frame function described later. Further, the first calculation unit 112 may calculate a required recall rate indicating a recall rate required for one video image frame as the analysis performance based on the number of frames in the required delay and the first function calculated above. Further, the second calculation unit 113 may calculate a required video image bit rate indicating a video image bit rate required for the video image as the parameter based on the required recall rate calculated by the first calculation unit 112 and a second function indicating a relationship between a recall rate and a video image bit rate. The second function corresponds to a Recall-to-video image bit rate function described later.

Further, the second function may be calculated by taking a variation in the recognition rate into account.

Further, the acquisition unit 111 may acquire the required quality in accordance with the target object.

Further, the video image distribution system 3 may further include an encoder that encodes the video image based on the required video image bit rate calculated by the second calculation unit 113, and a video image distribution unit that distributes the video image encoded by the encoder through a network. The encoder and the video image distribution unit correspond to an encoder 202 and a video image distribution unit 203 described later, respectively.

Further, the video image distribution system 3 may further include a guaranteed band setting unit that sets a guaranteed band for the network used for the distribution of the video image based on the required video image bit rate calculated by the second calculation unit 113. The guaranteed band setting unit corresponds to a guaranteed band setting unit 402 described later.

### Second Example Embodiment

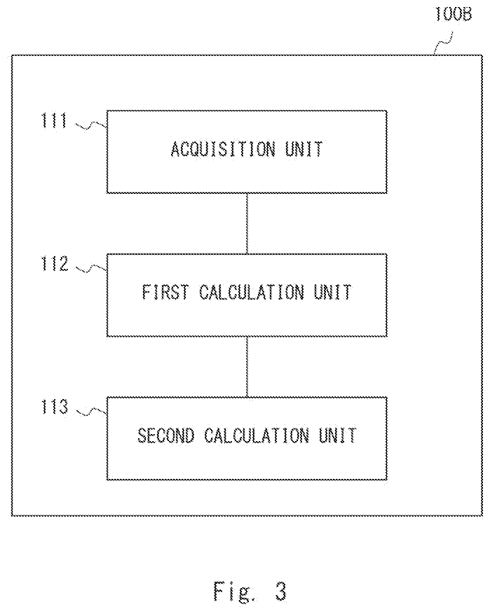

Next, an example of a configuration of a network management apparatus 100B according to a second example embodiment will be described with reference to FIG. 3. The second example embodiment corresponds to an example embodiment in which components provided in a distributed manner in the above-described first example embodiment are provided in one apparatus (the network management apparatus 100B) in an integrated manner.

That is, as shown in FIG. 3, the network management apparatus 100B according to the second example embodiment includes the acquisition unit 111, the first calculation unit 112, and the second calculation unit 113, which are components similar to those according to the above-described first example embodiment.

The second example embodiment differs from the first example embodiment only in that components similar to those according to the above-described first example embodiment are provided in the network management apparatus 100B in an integrated manner. Therefore, the operations and the effects in the second example embodiment are similar to those in the first example embodiment, and thus the descriptions thereof will be omitted.

### Overview of Each of Third to Fifth Example Embodiments

Each of third to fifth example embodiments described below is an example embodiment in which the above-described first and second example embodiments are made more concrete.

Prior to describing the third to the fifth example embodiments, an overview of each of the third to the fifth example embodiments will be described.

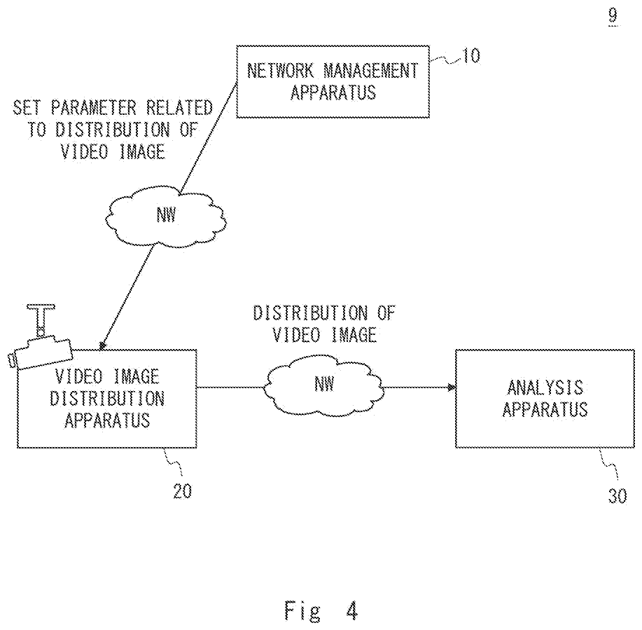

First, an example of a configuration of a video image distribution system 9 assumed in each of the third to the fifth example embodiments will be described with reference to FIG. 4.

As shown in FIG. 4, the video image distribution system 9 includes a network management apparatus 10, a video image distribution apparatus 20, and an analysis apparatus 30. Note that a network connecting the network management apparatus 10 to the video image distribution apparatus 20 may be a wired network or a wireless network. Further, a network connecting the video image distribution apparatus 20 to the analysis apparatus 30 is a wireless network.

Further, the wireless network may be Wireless Fidelity (Wifi), Long Term Evolution (LTE), 4G, 5G, or local 5G.

The video image distribution apparatus 20 is a camera such as a monitoring camera, and distributes a video image captured by the camera.

The analysis apparatus 30 analyzes the video image distributed by the video image distribution apparatus 20. For example, the analysis apparatus 30 recognizes a target object (e.g., a person, a face, a vehicle) included in the video image, thereby detecting the target object. Specifically, the analysis apparatus 30 performs binary classification as to whether or not a target object is included in the video image. As described above, the analysis apparatus 30 is used for a solution such as a detection of a target object.

The network management apparatus 10 determines a parameter related to the distribution of the video image by the video image distribution apparatus 20, and sets the determined parameter in the video image distribution apparatus 20. Examples of the parameter related to the distribution of the video image include a video image bit rate and a frame rate. When the parameter related to the distribution of the video image is a video image bit rate, the video image distribution apparatus 20 encodes the video image based on the video image bit rate set by the network management apparatus 10 and distributes it. The following description will be given in accordance with the assumption that the parameter related to the distribution of the video image is a video image bit rate.

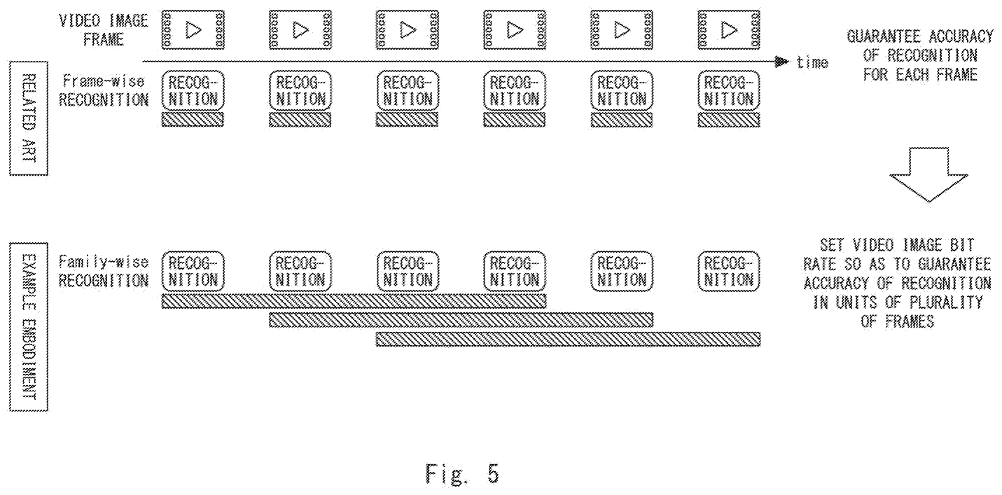

Next, an example of a method for setting a video image bit rate in each of the third to the fifth example embodiments and the related art will be described with reference to FIG. 5.

In the analysis of a video image by the analysis apparatus 30, a technology for analyzing one video image frame at a time is generally used. Therefore, the evaluation of the accuracy of recognition for each video image frame is a standard technology in the industry.

Therefore, when a technology in which the above-described technology disclosed in Patent Literature 1 is combined with the above-described standard technology in the industry is assumed as being the related art, it is considered that, in the related art, a video image bit rate is set so as to satisfy a required accuracy of recognition using an accuracy of recognition-to-video image bit rate function for each video image frame. That is, in the related art, as shown in the upper part of FIG. 5, it is considered that a video image bit rate is set so as to guarantee the accuracy of recognition of the target object for each video image frame in the analysis apparatus 30. Note that, in the upper part of FIG. 5, it is shown that rod-like hatched elements guarantee the accuracy of recognition for each video image frame. That is, it is considered that the network management apparatus 10 assumes that the analysis apparatus 30 performs Frame-wise recognition and then sets a video image bit rate.

However, in order to guarantee the accuracy of recognition for each video image frame, it is necessary to distribute a video image at a high video image bit rate. As a result, it is difficult to secure a sufficient communication band required for the distribution of the video image.

Therefore, in each of the third to the fifth example embodiments, as shown in the lower part of FIG. 5, in the analysis apparatus 30, a video image bit rate is set so as not to guarantee the accuracy of recognition of the target object for each video image frame but to guarantee the accuracy of recognition of the target object for at least one video image frame among N (N is an integer of two or greater) video image frames. That is, the network management apparatus 10 assumes that the analysis apparatus 30 performs Family-wise recognition and then sets a video image bit rate. Note that FIG. 5 shows an example of N=4, that is, an example in which it is guaranteed that a target object can be recognized in at least one video image frame among four video image frames. Therefore, in the lower part of FIG. 5, rod-like hatched elements indicate that the accuracy of recognition of a target object in at least one video image frame among four video image frames is guaranteed.

As described above, in each of the third to the fifth example embodiments, a video image bit rate is set so that it is guaranteed that a target object can be recognized in at least one video image frame among N video image frames although the probability that the target object will be able to be recognized in one video image frame is low. By doing so, the video image bit rate can be made lower than that of the related art, and it becomes easy to secure the communication band required for the distribution of the video image.

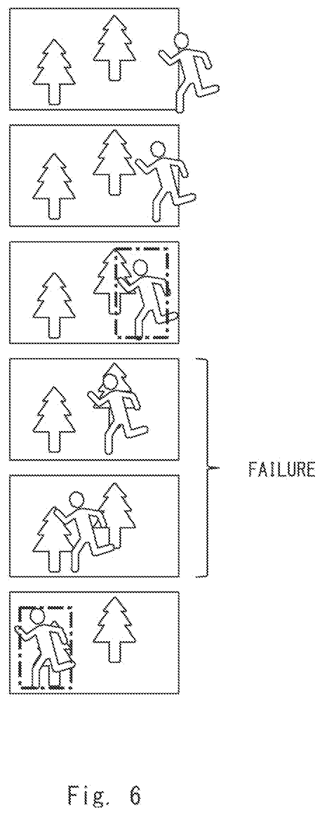

Next, Family-wise recognition performed in each of the third to the fifth example embodiments will be described with reference to FIG. 6 from a solution perspective.

FIG. 6 shows an example of video image frames used in the analysis apparatus 30 for a solution in which an alert is generated when a suspicious person is detected. FIG. 6 shows six video image frames. Further, in FIG. 6, the lower down in FIG. 6 a video image frame is, the newer the video image frame is, and when it is detected that a person is included in a video image frame, the person is surrounded by a frame.

In the example of FIG. 6, it is detected that a person is included in the third video image frame. However, in the following fourth and fifth video image frames, the person cannot be detected, that is, a detection failure has occurred, while in the sixth video image frame, the person is detected again.

In this way, when a detection failure has occurred but a similar context (in the example of FIG. 6, the person included in the video image frame) continuously appears for a certain period of time, an alert can be generated when the similar context can be detected in at least one video image frame among the following several video image frames.

However, this example does not assume a context included only in one video image frame since the context does not continuously appear for a certain period of time. For example, when a frame rate of the video image is 24 fps, this example does not assume a context included in only for a several 10 ms.

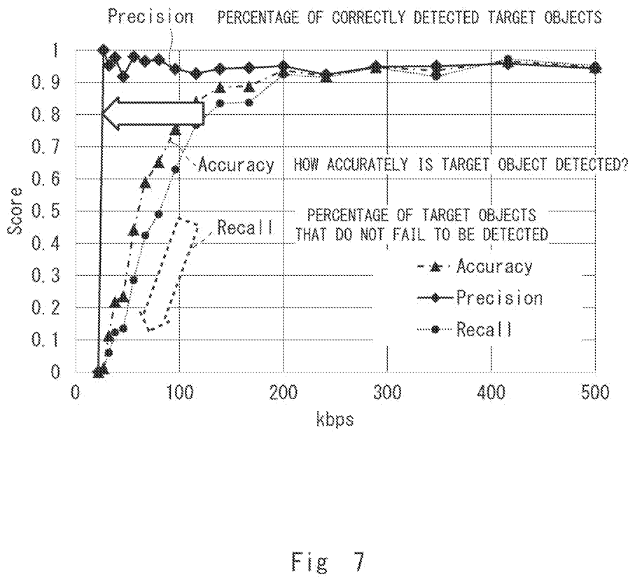

Next, Family-wise recognition performed in each of the third to the fifth example embodiments will be described with reference to FIG. 7 from a technical perspective.

FIG. 7 is a graph showing a relationship of a video image bit rate-to-accuracy score when the analysis apparatus 30 detects a target object. In FIG. 7, the horizontal axis indicates a video image bit rate, and the vertical axis indicates an accuracy score of each of Precision, Accuracy, and Recall. Precision indicates the percentage of correctly detected target objects, and is also referred to as a precision rate. Accuracy indicates how accurately the target object is detected, and is also referred to as an accuracy rate. Recall indicates the percentage of target objects that do not fail to be detected, and is also referred to as a recall rate. Each of Precision, Accuracy, and Recall is an example of an analysis performance for analyzing a video image which enables a target object to be recognized.

As shown in FIG. 7, an accuracy score of Precision is independent of a video image bit rate.

On the other hand, an accuracy score of Recall is dependent on a video image bit rate. However, when a video image bit rate is about 150 kbps, an accuracy score of about 0.9 or greater can be maintained. This shows that even when a video image bit rate is low and detection of a target object fails, the probability that the detection was correctly performed is about 90% or greater, as long as the target object can be detected in another video image frame.

In the third to the fifth example embodiments described below, a required video image bit rate required for distribution of a video image is calculated as a parameter related to the distribution of the video image. Note that it is important to reduce the number of times that detection failures occur in order to calculate the required video image bit rate. Therefore, in the third to the fifth example embodiments described below, Recall is used to calculate the required video image bit rate.

### Third Example Embodiment

The third example embodiment will be described below.

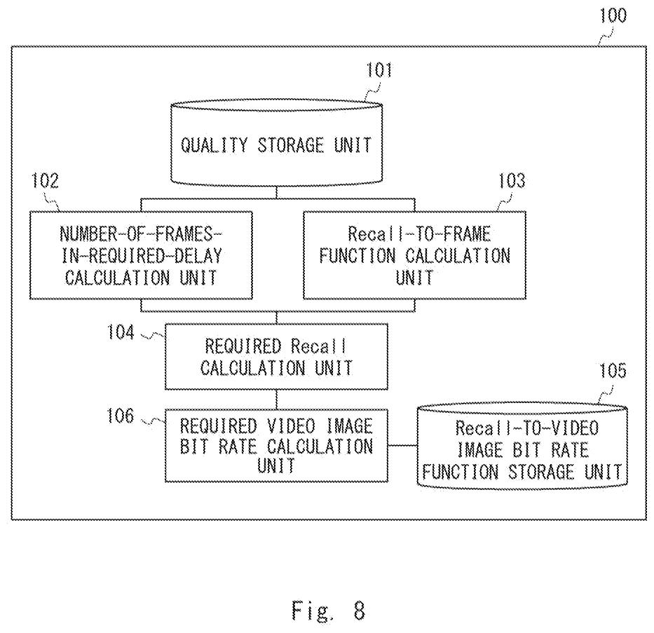

First, an example of a configuration of a network management apparatus 100 according to the third example embodiment will be described with reference to FIG. 8. The network management apparatus 100 according to the third example embodiment is, for example, a cloud server, a Multi-access Edge Computing (MEC) server, and an Edge apparatus, and can be installed in any place without restriction.

As shown in FIG. 8, the network management apparatus 100 according to the third example embodiment includes the quality storage unit 101, the number-of-frames-in-required-delay calculation unit 102, the Recall-to-frame function calculation unit 103, the required Recall calculation unit 104, the Recall-to-video image bit rate function storage unit 105, and the required video image bit rate calculation unit 106. Note that each component included in the network management apparatus 100 may be mounted on an apparatuses different from each other. For example, the quality storage unit 101 and the Recall-to-video image bit rate function storage unit 105 may be in the cloud. Further, each of the function calculation units (the number-of-frames-in-required-delay calculation unit 102, the Recall-to-frame function calculation unit 103, and the required Recall calculation unit 104) and the required video image bit rate calculation unit 106 may be installed in apparatuses different from each other and communicate with each other wirelessly or by wire to acquire information.

The quality storage unit 101 stores in advance a required quality (a required recognition quality) indicating quality (recognition quality) of the video image which the analysis apparatus (e.g., the analysis apparatus 30 shown in FIG. 4) requires from the video image distribution apparatus (e.g., the video image distribution apparatus 20 shown in FIG. 4) that distributes the video image in order to recognize a target object from the video image. Specifically, the quality storage unit 101 stores a required amount d[s] of delay and a required recognition rate p are stored in advance as the required quality. The required amount d[s] of delay indicates the upper limit of the amount of delay of a video image which the analysis apparatus requires from the video image distribution apparatus, and the required recognition rate p indicates a recognition rate of a video image which the analysis apparatus requires from the video image distribution apparatus.

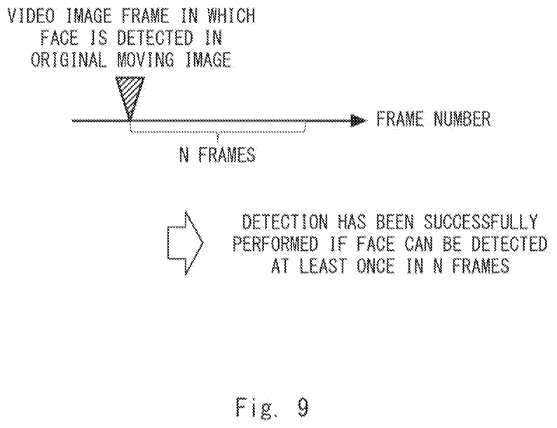

The definition of the recognition rate will be described below with reference to FIG. 9. FIG. 9 shows an example in which a target object to be detected is a face. In a video image in which a video image bit rate is changed, when a face is detected in N subsequent video image frames starting from a video image frame in which a face is detected in the original video image, and a face can be detected at least once in N video image frames, it is assumed that the detection has been successfully performed. Then, the statistics about success and failure of the detection are taken, and the percentage of the success is defined as a recognition rate.

Further, the quality storage unit 101 stores in advance a video image quality indicating the actual quality of a video image distributed by the video image distribution apparatus (e.g., the video image distribution apparatus 20 shown in FIG. 4) and received by the analysis apparatus. Specifically, the quality storage unit 101 stores in advance a frame rate m[fps] as a video image quality. Note that other examples of the video image quality include a bit rate and a resolution (a quantization parameter (a QP value)).

Note that the quality storage unit 101 may acquire the required amount d[s] of delay and the required recognition rate p from the analysis apparatus, and the frame rate m[fps] from the video image distribution apparatus or the analysis apparatus. Alternatively, the quality storage unit 101 may acquire the required amount d[s] of delay, the required recognition rate p, and the frame rate m[fps] by an input performed by a user.

The number-of-frames-in-required-delay calculation unit 102 calculates a number of frames nₘₐₓ in the required delay indicating the number of frames of a video image frame generated within the required amount d[s] of delay based on the required amount d[s] of delay and the frame rate m[fps] stored in the quality storage unit 101. When the required amount of delay is d[s] and the frame rate is m[fps], nₘₐₓ is calculated by the following expression 1.

$${n}_{max} = dm \qquad [ Expresion 1 ]$$

The Recall-to-frame function calculation unit 103 calculates, based on the required recognition rate p stored in the quality storage unit 101, a Recall-to-frame function indicating a relationship between Recall and the number of frames of a video image frame when the required recognition rate is p. The Recall-to-frame function serves as a function indicating the number of frames of the video image frame before the target object is recognized when the required recognition rate is p and Recall is q.

The probability that the target object will be recognized before the N-th video image frame when the required recognition rate is p and Recall is q is expressed by the following expression 2.

$$1 - {( 1 - q )}^{N} = P \qquad [ Expression 2 ]$$

The number of frames of the video image frame required for the recognition of the target object is expressed by the following expression 3 where the expression 2 is transformed.

$$N = ⌊ \frac{log 1 - p}{log 1 - q} ⌋ \qquad [ Expression 3 ]$$

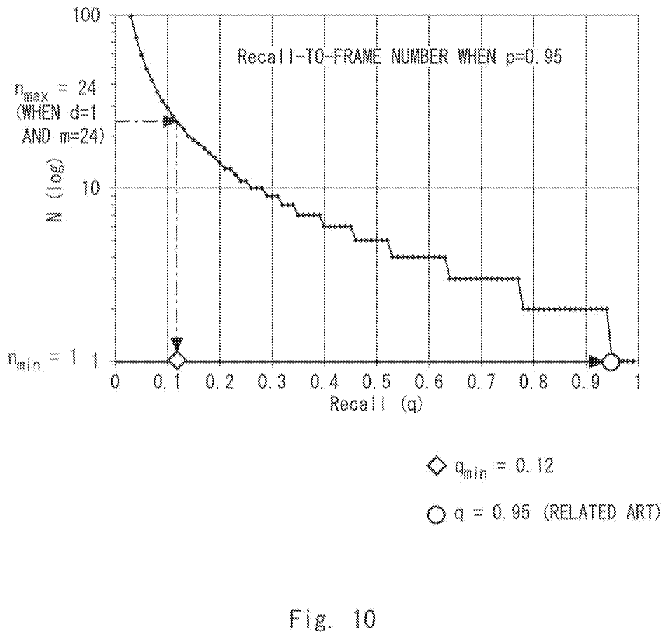

When the required recognition rate is p and Recall is q, the Recall-to-frame function calculation unit 103 calculates the above-described expression 3 as the Recall-to-frame function. FIG. 10 shows an example in which the above-described expression 3 is graphed when the required recognition rate p is 0.95. In FIG. 10, the horizontal axis indicates Recall, and the vertical axis indicates the number of frames of the video image frame.

The required Recall calculation unit 104 calculates a required Recall qₘᵢₙ indicating Recall required for one video image frame in order to recognize the target object before the N-th video image frame based on the number of frames nₘₐₓ in the required delay calculated by the number-of-frames-in-required-delay calculation unit 102 and the Recall-to-frame function calculated by the Recall-to-frame function calculation unit 103.

For example, when the required amount d of delay is 1[s] and the frame rate m is 24 [fps], the number of frames nₘₐₓ in the required delay calculated by the number-of-frames-in-required-delay calculation unit 102 becomes 24 by the expression 1. Further, FIG. 10 is a graph showing the Recall-to-frame function calculated by the Recall-to-frame function calculation unit 103 when the required recognition rate is 0.95. Therefore, the required Recall calculation unit 104 calculates a value 0.12 of Recall corresponding to nₘₐₓ=2⁴ as the required Recall qₘᵢₙ in the graph of FIG. 10.

Note that, in a case in which it is assumed that Frame-wise recognition is performed like in the case of the related art, the accuracy of recognition of a target object has to be guaranteed for each video image frame, and thus N is the minimum nₘᵢₙ and a value thereof is 1. In the graph of FIG. 10, the value of Recall corresponding to nₘᵢₙ=1 is 0.95, and this value is the required Recall.

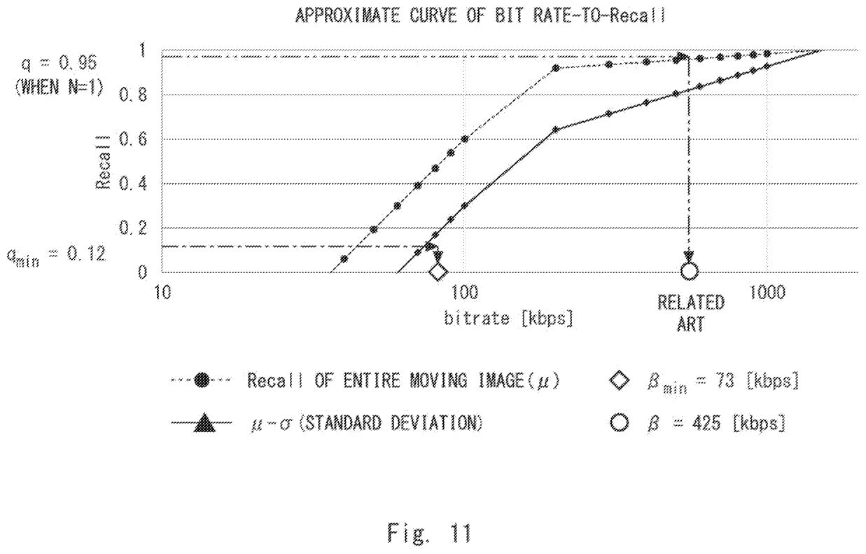

The Recall-to-video image bit rate function storage unit 105 stores a Recall-to-video image bit rate function indicating a relationship between Recall and the video image bit rate. An example of an approximate curve approximating the Recall-to-video image bit rate function is shown in FIG. 11. In FIG. 11, the horizontal axis indicates a video image bit rate, and the vertical axis indicates Recall. Further, in FIG. 11, two approximate curves are shown; a dotted approximate curve indicates Recall(μ) of the entire video image, and a solid approximate curve indicates μ-σ (standard deviation). The approximate curve of μ-σ has been derived because the variation in the recognition rate has been taken into account, and as will be described later, the required video image bit rate calculation unit 106 calculates a required video image bit rate using the approximate curve of μ-σ.

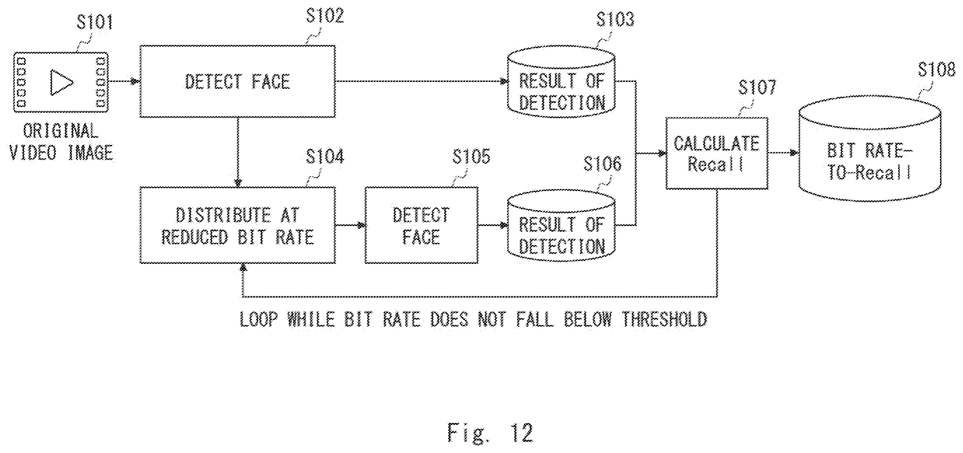

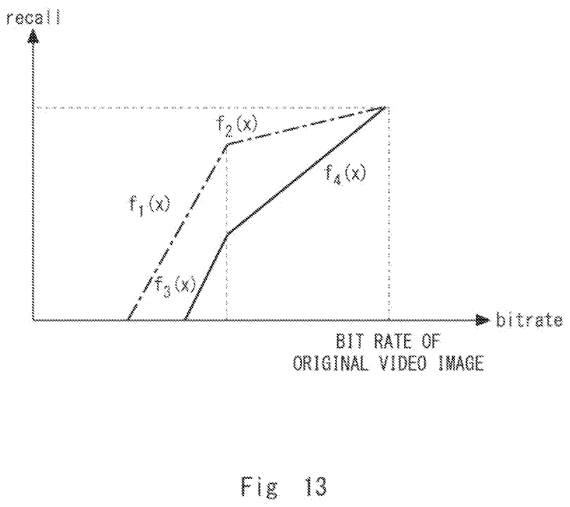

A method for creating two approximate curves shown in FIG. 11 will be described below with reference to FIGS. 12 and 13. Each of FIGS. 12 and 13 shows an example in which a target object to be detected is a face. Note that, for the sake of convenience, an operation subject that creates approximate curves is referred to here as a creation unit (not shown). The creation unit may be provided in the network management apparatus 10 or in another apparatus.

### (1) Collection of Video Image Bit Rate-to-Recall Data

First, as shown in FIG. 12, the creation unit receives a distributed original video image (Step S101), performs detection of a face (Step S102), stores a result of the detection (Step S103), and calculates Recall (Step S107). Next, the creation unit receives a distributed video image in which a video image bit rate has been reduced (Step S104), performs detection of a face (Step S105), stores a result of the detection (Step S106), and calculates Recall (Step S107). While the video image bit rate does not fall below a threshold, the creation unit repeats the loop of Steps S104 to S107. After that, the creation unit accumulates video image bit rate-to-Recall data indicating a relationship between the video image bit rate and Recall (Step S108).

### (2) Calculation of an Approximate Curve

Next, the creation unit performs fitting to the following expression 4 using the video image bit rate-to-Recall data, and as a result, the creation unit creates f₁(x) to f₄(x) as shown in FIG. 13.

$$y = {f}_{i} ( x ) = {a}_{i} {log}_{10} x + {b}_{i} \qquad [ Expression 4 ]$$

Note that, in the expression 4, x is a video image bit rate, y is Recall, and i={1, 2, 3, 4}.

Specifically, the creation unit first performs the above-described fitting to the expression 4, and creates f₁(x) and f₂(x). Next, the creation unit obtains the standard deviation a of f₁(x), and creates f₃(x) by f₁(x)−σ. Next, the creation unit connects a point corresponding to the bit rate of the original video image at f₂(x) to a point corresponding to the x-coordinate of the intersection of f₁(x) and f₂(x) at f₃(x), and defines it as f₄(x). Therefore, a₁=a₃ holds. Further, the intersection of f₁(x) and f₂(x) and the intersection of f₃(x) and f₄(x) have the same x-coordinate.

In the way described above, f₁(x) to f₄(x) as shown in FIG. 13 are created. Among them, the approximate curve formed of f₁(x) and f₂(x) is the approximate curve corresponding to p shown in FIG. 11. Further, the approximate curve formed of f₃(x) and f₄(x) is the approximate curve corresponding to μ-σ shown in FIG. 11.

The required video image bit rate calculation unit 106 calculates a required video image bit rate βₘᵢₙ indicating a video image bit rate required for the video image in order to recognize the target object before the N-th video image frame based on the required Recall qₘᵢₙ calculated by the required Recall calculation unit 104 and the Recall-to-video image bit rate function stored in the Recall-to-video image bit rate function storage unit 105.

For example, when the required Recall qₘᵢₙ=0.12 and the approximate curve of the Recall-to-video image bit rate function is as shown in FIG. 11, a video image bit rate corresponding to qₘᵢₙ=0.12 is 73 [kbps] in the approximate curve of μ-σ shown in FIG. 11. Therefore, the required video image bit rate calculation unit 106 calculates 73 [kbps] as the required video image bit rate βₘᵢₙ.

Note that, in a case in which it is assumed that Frame-wise recognition is performed like in the case of the related art, N=1, and thus that the required Recall is 0.95 as described above. In the approximate curve of p shown in FIG. 11, a video image bit rate corresponding to q=0.95 is 425 [kbps]. Therefore, 425 [kbps] is the required video image bit rate.

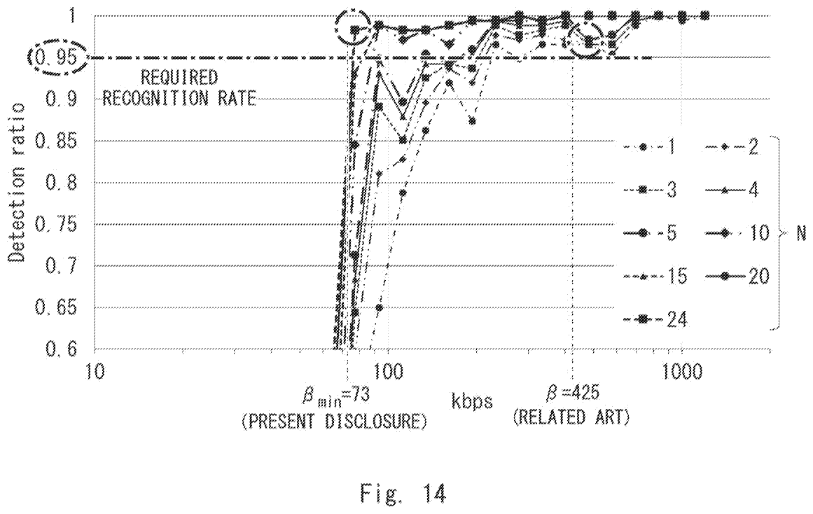

Next, an example of a result of a video image bit rate-to-recognition rate (a recognition rate of Family-wise recognition) will be described with reference to FIG. 14. In FIG. 14, the horizontal axis indicates a video image bit rate, and the vertical axis indicates a recognition rate.

In a case in which it is assumed that Frame-wise recognition is performed like in the case of the related art, N=1, and the required video image bit rate is 425 [kbps]. In this case, although the required recognition rate (0.95) or greater can be maintained, the required video image bit rate increases.

On the other hand, in a case in which it is assumed that Family-wise recognition is performed like in the case of the third example embodiment, N=24, and the required video image bit rate is 73 [kbps]. In this case, although the required video image bit rate is low, the required recognition rate (0.95) or greater can be maintained.

Therefore, according to the third example embodiment, the required recognition rate (0.95) or greater can be maintained while the video image bit rate is reduced (from 425 [kbps] to 73 [kbps]).

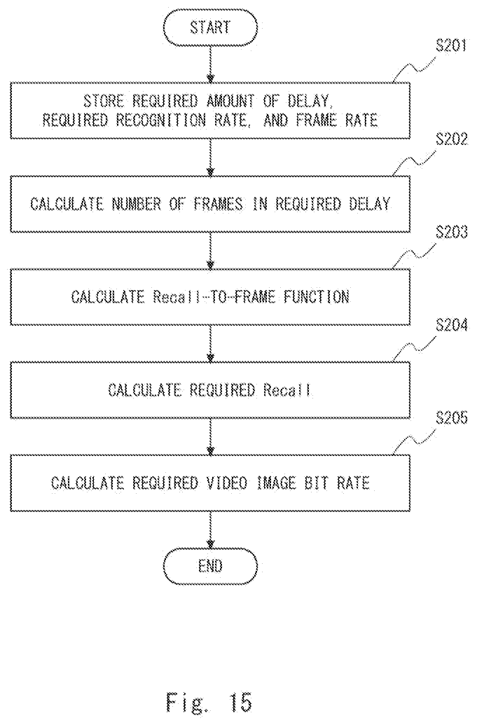

Next, an example of a schematic operation flow of the network management apparatus 100 according to the third example embodiment will be described with reference to FIG. 15.

As shown in FIG. 15, the quality storage unit 101 first stores a required amount of delay, a required recognition rate, and a frame rate (Step S201).

Next, the number-of-frames-in-required-delay calculation unit 102 calculates the number of frames in the required delay based on the required amount of delay and the frame rate stored in the quality storage unit 101 (Step S202).

Next, the Recall-to-frame function calculation unit 103 calculates, based on the required recognition rate stored in the quality storage unit 101, a Recall-to-frame function when the required recognition rate is the stored required recognition rate (Step S203).

Note that the processes in Steps S202 and S203 may be performed in the reverse order or simultaneously in parallel.

Next, the required Recall calculation unit 104 calculates Recall required for one video image frame based on the number of frames in the required delay calculated by the number-of-frames-in-required-delay calculation unit 102 and the Recall-to-frame function calculated by the Recall-to-frame function calculation unit 103 (Step S204).

After that, the required video image bit rate calculation unit 106 calculates a required video image bit rate based on the required Recall calculated by the required Recall calculation unit 104 and the Recall-to-video image bit rate function stored in the Recall-to-video image bit rate function storage unit 105 (Step S205).

As described above, according to the third example embodiment, the required video image bit rate is calculated assuming Family-wise recognition.

That is, Recall required for one video image frame is calculated so that a recognition rate indicating a rate at which the target object is recognized in at least one video image frame among N video image frames satisfies the required recognition rate, and a required video image bit rate is calculated based on the calculated required Recall.

By doing so, the video image bit rate can be kept lower while maintaining the required recognition rate (the accuracy of recognition) than in the case in which it is assumed that Frame-wise recognition is performed, and thus the video image can be efficiently distributed. Further, since the video image bit rate can be kept low, a communication band required for the distribution of the video image can also be reduced.

### Fourth Example Embodiment

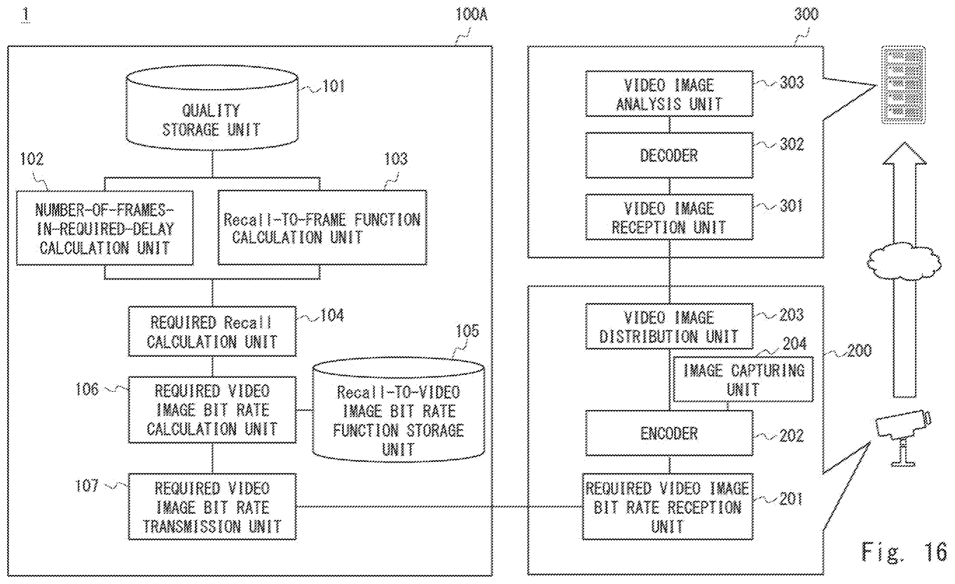

Next, an example of a configuration of a video image distribution system 1 according to a fourth example embodiment will be described with reference to FIG. 16.

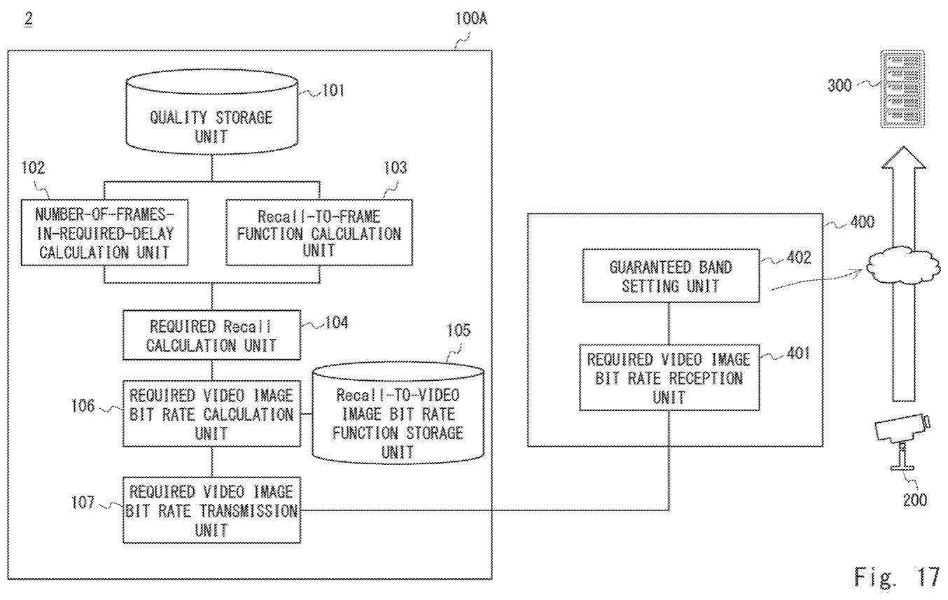

As shown in FIG. 16, the video image distribution system 1 according to the fourth example embodiment includes a network management apparatus 100A, a video image distribution apparatus 200, and an analysis apparatus 300. Note that the wireless network connecting the video image distribution apparatus 200 to the analysis apparatus 300 may be Wifi, LTE, 4G, 5G, or local 5G (the same applies to FIG. 17 described below).

The network management apparatus 100A differs from the network management apparatus 100 according to the first example embodiment described above in that a required video image bit rate transmission unit 107 is added.

The required video image bit rate transmission unit 107 transmits information about the required video image bit rate calculated by the required video image bit rate calculation unit 106 to the video image distribution apparatus 200.

The video image distribution apparatus 200 is an apparatus that distributes a video image, and is, for example, a camera typified by a monitoring camera. The video image distribution apparatus 200 includes a required video image bit rate reception unit 201, the encoder 202, the video image distribution unit 203, and an image capturing unit 204.

The required video image bit rate reception unit 201 receives information about the required video image bit rate from the network management apparatus 100A.

The image capturing unit 204 captures a video image.

The encoder 202 encodes a video image captured by the image capturing unit 204 based on the required video image bit rate received by the required video image bit rate reception unit 201.

The video image distribution unit 203 transmits the video image encoded by the encoder 202 to the analysis apparatus 300 through a network.

The analysis apparatus 300 is an apparatus that analyzes a video image, and is a cloud server or the like. The analysis apparatus 300 includes a video image reception unit 301, a decoder 302, and a video image analysis unit 303.

The video image reception unit 301 receives a video image from the video image distribution apparatus 200 through a network.

The decoder 302 decodes the video image received by the video image reception unit 301.

The video image analysis unit 303 analyzes the video image decoded by the decoder 302. For example, the video image analysis unit 303 recognizes a target object (e.g., a person, a face, a vehicle) included in the video image, thereby detecting the target object. Specifically, the video image analysis unit 303 performs binary classification as to whether or not a target object is included in the video image.

As described above, according to the fourth example embodiment, the video image distribution apparatus 200 can encode a video image captured by the image capturing unit 204 based on the required video image bit rate calculated by the network management apparatus 100A, and distribute it to the analysis apparatus 300. Further, since the required video image bit rate calculated by the network management apparatus 100A is calculated so as to satisfy the required recognition rate assuming Family-wise recognition, the accuracy of detection of the target object in the analysis apparatus 300 can be maintained.

### Fifth Example Embodiment

Next, an example of a configuration of a video image distribution system 2 according to a fifth example embodiment will be described with reference to FIG. 17.

As shown in FIG. 17, the video image distribution system 2 according to the fifth example embodiment includes the network management apparatus 100A and a band control apparatus 400.

A configuration of the network management apparatus 100A is similar to that of the network management apparatus 100A according to the fourth example embodiment described above. However, the transmission destination of the required video image bit rate information is the band control apparatus 400.

The band control apparatus 400 is an apparatus that controls the band of a network, and is, for example, a router disposed between the video image distribution apparatus 200 and the analysis apparatus 300. However, the band control apparatus 400 may be a router or the like disposed between the video image distribution apparatus 200 and a video image reception apparatus (not shown). The band control apparatus 400 includes a required video image bit rate reception unit 401 and the guaranteed band setting unit 402.

The required video image bit rate reception unit 401 receives information about the required video image bit rate from the network management apparatus 100A.

The guaranteed band setting unit 402 sets a guaranteed band for the network used for the distribution of the video image performed by the video image distribution apparatus 200 based on the required video image bit rate received by the required video image bit rate reception unit 401

As described above, according to the third example embodiment, the band control apparatus 400 can set a guaranteed band for the network used for the distribution of the video image performed by the video image distribution apparatus 200 based on the required video image bit rate calculated by the network management apparatus 100A.

### Hardware Configuration of the Network Management Apparatus According to the Example Embodiment

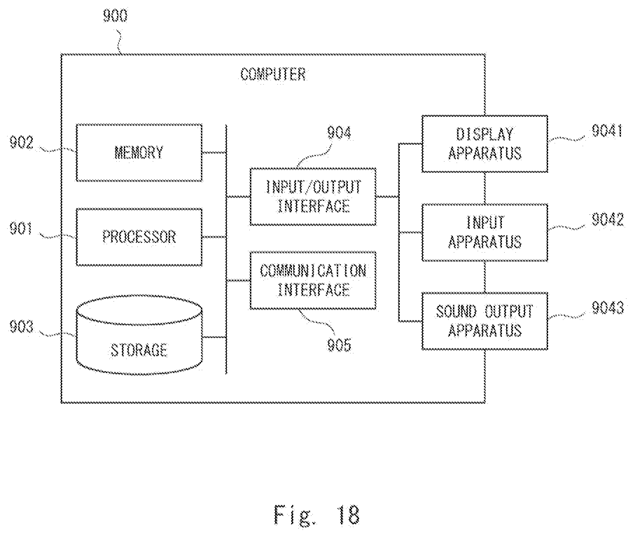

Next, an example of a hardware configuration of a computer 900 that implements the network management apparatuses 100, 100A, and 100B according to the second to the fifth example embodiments described above will be described with reference to FIG. 18.

As shown in FIG. 18, the computer 900 includes a processor 901, a memory 902, a storage 903, an input/output interface (an input/output I/F) 904, a communication interface (a communication I/F) 905, and the like. The processor 901, the memory 902, the storage 903, the input/output interface 904, and the communication interface 905 are connected to each other by data transmission lines through which they transmit/receive data to/from each other.

The processor 901 is, for example, an arithmetic processing apparatus such as a Central Processing Unit (CPU) or a Graphics Processing Unit (GPU). The memory 902 is, for example, a memory such as a Random Access Memory (RAM) or a Read Only Memory (ROM). The storage 903 is, for example, a storage device such as a Hard Disk Drive (HDD), a Solid State Drive (SSD), or a memory card. Further, the storage 903 may be a memory such as a RAM or a ROM.

The storage 903 stores programs for implementing the functions of the components included in the network management apparatuses 100, 100A, and 100B. The processor 901 implements the functions of each of the components included in the network management apparatuses 100, 100A, and 100B by executing the respective programs. Note that when the processor 901 executes these respective programs, it may execute the programs after loading them onto the memory 902 or may execute the programs without loading them onto the memory 902. Further, the memory 902 and the storage 903 also serve to implement the storage functions provided in the network management apparatuses 100, 100A, and 100B.

The above-described programs include instructions (or software codes) that, when loaded into a computer, cause the computer to perform one or more of the functions in the network management apparatuses 100, 100A, and 100B described in the above-described example embodiments. The programs may be stored in a non-transitory computer readable medium or a tangible storage medium. By way of example, and not a limitation, non-transitory computer readable media or tangible storage media can include a RAM, a ROM, a flash memory, a SSD or other types of memory technologies, a compact disc (CD)-ROM, a digital versatile disc (DVD), a Blu-ray (Registered Trademark) disc or other types of optical disc storage, a magnetic cassette, a magnetic tape, and a magnetic disk storage or other types of magnetic storage devices. The programs may be transmitted on a transitory computer readable medium or a communication medium. By way of example, and not a limitation, transitory computer readable media or communication media can include electrical, optical, acoustical, or other forms of propagated signals.

The input/output interface 904 is connected to a display apparatus 9041, an input apparatus 9042, a sound output apparatus 9043, and the like. The display apparatus 9041 is an apparatus, such as a Liquid Crystal Display (LCD), a Cathode Ray Tube (CRT) display, or a monitor, which displays a screen corresponding to drawing data processed by the processor 901. The input apparatus 9042 is an apparatus that receives an operation input from an operator, and is, for example, a keyboard, a mouse, and a touch sensor. The display apparatus 9041 and the input apparatus 9042 may be integrated with each other and hence implemented as a touch panel. The sound output apparatus 9043 is an apparatus, such as a speaker, which outputs sounds corresponding to acoustic data processed by the processor 901.

The communication interface 905 transmits and receives data to and from an external apparatus. For example, the communication interface 905 communicates with an external apparatus through a wired communication line or a wireless communication line.

Although the present disclosure has been described with reference to the example embodiments, the present disclosure is not limited to the above-described example embodiments. Various changes that may be understood by those skilled in the art may be made to the configurations and details of the present disclosure within the scope of the disclosure.

Further, the whole or part of the example embodiments disclosed above can be described as, but not limited to, the following supplementary notes.

### (Supplementary Note 1)

A network management apparatus comprising:
an acquisition unit configured to acquire, in order to recognize a target object from a video image, a required quality indicating quality of the video image required by a video image distribution apparatus configured to distribute the video image;
a first calculation unit configured to calculate an analysis performance for analyzing the video image based on the required quality acquired by the acquisition unit, the analysis performance enabling the target object to be recognized; and
a second calculation unit configured to calculate a parameter related to the distribution of the video image based on the analysis performance calculated by the first calculation unit.

### (Supplementary Note 2)

The network management apparatus according to supplementary note 1, wherein
the acquisition unit further acquires a video image quality of the video image, and
the first calculation unit calculates the analysis performance based on the required quality and the video image quality acquired by the acquisition unit.

### (Supplementary Note 3)

The network management apparatus according to supplementary note 2, wherein
the acquisition unit acquires a required recognition rate indicating a recognition rate required for the video image and a required amount of delay indicating an upper limit of an amount of delay required for the video image as the required quality, and acquires a frame rate of the video image as the video image quality, and
the recognition rate is a rate at which the target object is recognized in at least one video image frame among a plurality of video image frames.

### (Supplementary Note 4)

The network management apparatus according to supplementary note 3, wherein
the first calculation unit calculates the number of frames in the required delay indicating the number of frames of the video image frame generated within the required amount of delay based on the required amount of delay and the frame rate acquired by the acquisition unit,
the first calculation unit calculates a first function indicating a relationship between a recall rate and the number of frames of the video image frame when the required recognition rate is the required recognition rate acquired by the acquisition unit,
the first calculation unit calculates a required recall rate indicating a recall rate required for one video image frame as the analysis performance based on the calculated number of frames in the required delay and the calculated first function, and
the second calculation unit calculates a required video image bit rate indicating a video image bit rate required for the video image as the parameter based on the required recall rate calculated by the first calculation unit and a second function indicating a relationship between a recall rate and a video image bit rate.

### (Supplementary Note 5)

The network management apparatus according to supplementary note 4, wherein the second function is calculated by taking a variation in the recognition rate into account.

### (Supplementary Note 6)

The network management apparatus according to any one of supplementary notes 1 to 5, wherein the acquisition unit acquires the required quality in accordance with the target object.

(Supplementary Note 7) A network management method comprising:
an acquisition step of acquiring, in order to recognize a target object from a video image, a required quality indicating quality of the video image required by a video image distribution apparatus configured to distribute the video image;
a first calculation step of calculating an analysis performance for analyzing the video image based on the required quality acquired in the acquisition step, the analysis performance enabling the target object to be recognized; and
a second calculation step of calculating a parameter related to the distribution of the video image based on the analysis performance calculated in the first calculation step.

### (Supplementary Note 8)

The network management method according to supplementary note 7, wherein
in the acquisition step, a video image quality of the video image is further acquired, and
in the first calculation step, the analysis performance is calculated based on the required quality and the video image quality acquired in the acquisition step.

### (Supplementary Note 9)

The network management method according to supplementary note 8, wherein
in the acquisition step, a required recognition rate indicating a recognition rate required for the video image and a required amount of delay indicating an upper limit of an amount of delay required for the video image are acquired as the required quality, and a frame rate of the video image is acquired as the video image quality, and
the recognition rate is a rate at which the target object is recognized in at least one video image frame among a plurality of video image frames.

### (Supplementary Note 10)

The network management method according to supplementary note 9, wherein
in the first calculation step,
   the number of frames in the required delay indicating the number of frames of the video image frame generated within the required amount of delay is calculated based on the required amount of delay and the frame rate acquired in the acquisition step,
   a first function indicating a relationship between a recall rate and the number of frames of the video image frame when the required recognition rate is the required recognition rate acquired in the acquisition step is calculated, and
   a required recall rate indicating a recall rate required for one video image frame is calculated as the analysis performance based on the calculated number of frames in the required delay and the calculated first function, and
in the second calculation step, a required video image bit rate indicating a video image bit rate required for the video image is calculated as the parameter based on the required recall rate calculated by the first calculation unit and a second function indicating a relationship between a recall rate and a video image bit rate.

### (Supplementary Note 11)

The network management method according to supplementary note 10, wherein the second function is calculated by taking a variation in the recognition rate into account.

### (Supplementary Note 12)

The network management method according to any one of supplementary notes 7 to 11, wherein in the acquisition step, the required quality in accordance with the target object is acquired.

### (Supplementary Note 13)

A video image distribution system comprising:
an acquisition unit configured to acquire, in order to recognize a target object from a video image, a required quality indicating quality of the video image required by a video image distribution apparatus configured to distribute the video image;
a first calculation unit configured to calculate an analysis performance for analyzing the video image based on the required quality acquired by the acquisition unit, the analysis performance enabling the target object to be recognized; and
a second calculation unit configured to calculate a parameter related to the distribution of the video image based on the analysis performance calculated by the first calculation unit.

### (Supplementary Note 14)

The video image distribution system according to supplementary note 13, wherein
the acquisition unit further acquires a video image quality of the video image, and
the first calculation unit calculates the analysis performance based on the required quality and the video image quality acquired by the acquisition unit.

### (Supplementary Note 15)

The video image distribution system according to supplementary note 14, wherein
the acquisition unit acquires a required recognition rate indicating a recognition rate required for the video image and a required amount of delay indicating an upper limit of an amount of delay required for the video image as the required quality, and acquires a frame rate of the video image as the video image quality, and
the recognition rate is a rate at which the target object is recognized in at least one video image frame among a plurality of video image frames.

### (Supplementary Note 16)

The video image distribution system according to supplementary note 15, wherein
the first calculation unit calculates the number of frames in the required delay indicating the number of frames of the video image frame generated within the required amount of delay based on the required amount of delay and the frame rate acquired by the acquisition unit,
the first calculation unit calculates a first function indicating a relationship between a recall rate and the number of frames of the video image frame when the required recognition rate is the required recognition rate acquired by the acquisition unit,
the first calculation unit calculates a required recall rate indicating a recall rate required for one video image frame as the analysis performance based on the calculated number of frames in the required delay and the calculated first function, and
the second calculation unit calculates a required video image bit rate indicating a video image bit rate required for the video image as the parameter based on the required recall rate calculated by the first calculation unit and a second function indicating a relationship between a recall rate and a video image bit rate.

### (Supplementary Note 17)

The video image distribution system according to supplementary note 16, wherein the second function is calculated by taking a variation in the recognition rate into account.

### (Supplementary Note 18)

The video image distribution system according to supplementary note 16 or 17, further comprising:
an encoder configured to encode the video image based on the required video image bit rate calculated by the second calculation unit; and
a video image distribution unit configured to distribute the video image encoded by the encoder through a network.

### (Supplementary Note 19)

The video image distribution system according to supplementary note 16 or 17, further comprising a guaranteed band setting unit configured to set a guaranteed band for the network used for the distribution of the video image based on the required video image bit rate calculated by the second calculation unit.

### (Supplementary Note 20)

The video image distribution system according to any one of supplementary notes 13 to 19, wherein the acquisition unit acquires the required quality in accordance with the target object.

### REFERENCE SIGNS LIST

1, 2, 3 VIDEO IMAGE DISTRIBUTION SYSTEM
100, 100A, 100B NETWORK MANAGEMENT APPARATUS
101 QUALITY STORAGE UNIT
102 NUMBER-OF-FRAMES-IN-REQUIRED-DELAY CALCULATION UNIT
103 RECALL-TO-FRAME FUNCTION CALCULATION UNIT
104 REQUIRED RECALL CALCULATION UNIT
105 RECALL-TO-VIDEO IMAGE BIT RATE FUNCTION STORAGE UNIT
106 REQUIRED VIDEO IMAGE BIT RATE CALCULATION UNIT
107 REQUIRED VIDEO IMAGE BIT RATE TRANSMISSION UNIT
111 ACQUISITION UNIT
112 FIRST CALCULATION UNIT
113 SECOND CALCULATION UNIT
200 VIDEO IMAGE DISTRIBUTION APPARATUS
201 REQUIRED VIDEO IMAGE BIT RATE RECEPTION UNIT
202 ENCODER
203 VIDEO IMAGE DISTRIBUTION UNIT
204 IMAGE CAPTURING UNIT
300 ANALYSIS APPARATUS
301 VIDEO IMAGE RECEPTION UNIT
302 DECODER
303 VIDEO IMAGE ANALYSIS UNIT
400 BAND CONTROL APPARATUS
401 REQUIRED VIDEO IMAGE BIT RATE RECEPTION UNIT
402 GUARANTEED BAND SETTING UNIT
900 COMPUTER
901 PROCESSOR
902 MEMORY
903 STORAGE
904 INPUT/OUTPUT INTERFACE
9041 DISPLAY APPARATUS
9042 INPUT APPARATUS
9043 SOUND OUTPUT APPARATUS
905 COMMUNICATION INTERFACE

What is claimed is:

1. A network management apparatus comprising:
at least one memory storing instructions, and
at least one processor configured to execute the instructions to;
acquire, in order to recognize a target object from a video image, a required quality indicating quality of the video image required by a video image distribution apparatus configured to distribute the video image;
calculate an analysis performance for analyzing the video image based on the acquired required quality, the analysis performance enabling the target object to be recognized; and
calculate a parameter related to the distribution of the video image based on the calculated analysis performance.

2. The network management apparatus according to claim 1, wherein
the at least one processor is further configured to execute the instructions to;
further acquire a video image quality of the video image, and
calculate the analysis performance based on the acquired required quality and the acquired video image quality.

3. The network management apparatus according to claim 2, wherein
the at least one processor is further configured to execute the instructions to acquire a required recognition rate indicating a recognition rate required for the video image and a required amount of delay indicating an upper limit of an amount of delay required for the video image as the required quality, and acquires a frame rate of the video image as the video image quality, and
the recognition rate is a rate at which the target object is recognized in at least one video image frame among a plurality of video image frames.

4. The network management apparatus according to claim 3, wherein
the at least one processor is further configured to execute the instructions to;
calculate the number of frames in the required delay indicating the number of frames of the video image frame generated within the required amount of delay based on the acquired required amount of delay and the acquired frame rate,
calculate a first function indicating a relationship between a recall rate and the number of frames of the video image frame when the required recognition rate is the acquired required recognition rate,
calculate a required recall rate indicating a recall rate required for one video image frame as the analysis performance based on the calculated number of frames in the required delay and the calculated first function, and
calculate a required video image bit rate indicating a video image bit rate required for the video image as the parameter based on the calculated required recall rate and a second function indicating a relationship between a recall rate and a video image bit rate.

5. The network management apparatus according to claim 4, wherein the second function is calculated by taking a variation in the recognition rate into account.

6. The network management apparatus according to claim 1, wherein the at least one processor is further configured to execute the instructions to acquire the required quality in accordance with the target object.

7. A network management method comprising:
an acquisition step of acquiring, in order to recognize a target object from a video image, a required quality indicating quality of the video image required by a video image distribution apparatus configured to distribute the video image;
a first calculation step of calculating an analysis performance for analyzing the video image based on the required quality acquired in the acquisition step, the analysis performance enabling the target object to be recognized; and
a second calculation step of calculating a parameter related to the distribution of the video image based on the analysis performance calculated in the first calculation step.

8. The network management method according to claim 7, wherein
in the acquisition step, a video image quality of the video image is further acquired, and
in the first calculation step, the analysis performance is calculated based on the required quality and the video image quality acquired in the acquisition step.

9. The network management method according to claim 8, wherein
in the acquisition step, a required recognition rate indicating a recognition rate required for the video image and a required amount of delay indicating an upper limit of an amount of delay required for the video image are acquired as the required quality, and a frame rate of the video image is acquired as the video image quality, and
the recognition rate is a rate at which the target object is recognized in at least one video image frame among a plurality of video image frames.

10. The network management method according to claim 9, wherein
in the first calculation step,
the number of frames in the required delay indicating the number of frames of the video image frame generated within the required amount of delay is calculated based on the required amount of delay and the frame rate acquired in the acquisition step,
a first function indicating a relationship between a recall rate and the number of frames of the video image frame when the required recognition rate is the required recognition rate acquired in the acquisition step is calculated, and
a required recall rate indicating a recall rate required for one video image frame is calculated as the analysis performance based on the calculated number of frames in the required delay and the calculated first function, and
in the second calculation step, a required video image bit rate indicating a video image bit rate required for the video image is calculated as the parameter based on the required recall rate calculated by the first calculation unit and a second function indicating a relationship between a recall rate and a video image bit rate.

11. The network management method according to claim 10, wherein the second function is calculated by taking a variation in the recognition rate into account.

12. The network management method according to claim 7, wherein in the acquisition step, the required quality in accordance with the target object is acquired.

13. A video image distribution system comprising:
at least one memory storing instructions, and
at least one processor configured to execute the instructions to;
acquire, in order to recognize a target object from a video image, a required quality indicating quality of the video image required by a video image distribution apparatus configured to distribute the video image;
calculate an analysis performance for analyzing the video image based on the acquired required quality, the analysis performance enabling the target object to be recognized; and
calculate a parameter related to the distribution of the video image based on the calculated analysis performance.

14. The video image distribution system according to claim 13, wherein
the at least one processor is further configured to execute the instructions to;
further acquire a video image quality of the video image, and
calculate the analysis performance based on the acquired required quality and the acquired video image quality.

15. The video image distribution system according to claim 14, wherein
the at least one processor is further configured to execute the instructions to acquire a required recognition rate indicating a recognition rate required for the video image and a required amount of delay indicating an upper limit of an amount of delay required for the video image as the required quality, and acquires a frame rate of the video image as the video image quality, and
the recognition rate is a rate at which the target object is recognized in at least one video image frame among a plurality of video image frames.

16. The video image distribution system according to claim 15, wherein
the at least one processor is further configured to execute the instructions to;
calculate the number of frames in the required delay indicating the number of frames of the video image frame generated within the required amount of delay based on the acquired required amount of delay and the acquired frame rate,
calculate a first function indicating a relationship between a recall rate and the number of frames of the video image frame when the required recognition rate is the acquired required recognition rate,
calculate a required recall rate indicating a recall rate required for one video image frame as the analysis performance based on the calculated number of frames in the required delay and the calculated first function, and
calculate a required video image bit rate indicating a video image bit rate required for the video image as the parameter based on the calculated required recall rate and a second function indicating a relationship between a recall rate and a video image bit rate.

17. The video image distribution system according to claim 16, wherein the second function is calculated by taking a variation in the recognition rate into account.

18. The video image distribution system according to claim 16, wherein
the at least one processor is further configured to execute the instructions to:
encode the video image based on the calculated required video image bit rate; and
distribute the encoded video image through a network.

19. The video image distribution system according to claim 16, wherein the at least one processor is further configured to execute the instructions to set a guaranteed band for the network used for the distribution of the video image based on the calculated required video image bit rate.

20. The video image distribution system according to claim 13, wherein the at least one processor is further configured to execute the instructions to acquire the required quality in accordance with the target object.
